(19) United States
(12) Patent Application Publication
(10) Pub. No.: US 2006/0026459 A1
(43) Pub. Date: Feb. 2, 2006

(54) Method and apparatus for storing data

(75) Inventors: Hiroshi Otsuka, Kawasaki (JP); Yasuhiro Onda, Nagoya (JP); Fumio Yamazaki, Nagoya (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/984,996

(22) Filed: Nov. 10, 2004

(30) Foreign Application Priority Data
Jul. 28, 2004 (JP) 2004-220814

(51) Int. Cl. G06F 11/00; G06F 12/16

(52) U.S. Cl. 714/6; 711/162

(57) ABSTRACT

An apparatus for storing data received from other apparatus includes a first storage unit that stores the data received from the other apparatus; a second storage unit that stores the data stored in the first storage unit; a history storage unit that stores information on a storage history of the data that is written from the first storage unit into the second storage unit; and a data recalling unit that reads out the data stored in the second storage unit and stores the data read out to the first storage unit based on the information on the storage history.

### BACKGROUND OF THE INVENTION

1) Field of the Invention

The present invention relates to a technology for storing data received from other apparatus, which can execute a backing up or a recalling process easily and efficiently with an increased usability.

2) Description of the Related Art

Conventionally, loss of data stored in a computer system is safeguarded by storing the data on a magnetic tape as a backup. Magnetic tapes are suitable for data backup since it has a larger data storage capacity than a hard disk apparatus, and is less expensive.

Since data stored in a hard disk apparatus of a general computer system is updated, the magnetic tape is regularly backed up. Methods for backing up data include backing up all data at a specific time, or backing up only a portion of the backed-up data that is different when the data has been backed up.

Each of these methods has the drawback of poor usability, since a magnetic tape for storing the data, and software for executing back-up must be provided in order to back up the data, and backup must be performed manually.

In view of this, there is disclosed a magnetic tape cartridge control system that backs up data by using a control apparatus that controls backup of data to the magnetic tape, and an auto-changer that automatically replaces the magnetic tape cartridge, thereby enabling the cartridge to be replaced automatically without requiring a manual operation (see, for example, Japanese Patent Application Laid-Open No. H9-69082).

In this magnetic tape cartridge control system, a storage region of one roll of a magnetic tape cartridge is divided into a plurality of storage regions, and data is backed up into the divided storage regions as data of different generations, so as to carry out data backup generation management.

However, although the above conventional art backs up data automatically, it does not enable the user to easily recall the backed-up data to the hard disk apparatus.

There is a problem in that, when recalling data, the user must retrieve and select the data to be recalled from among the different generations of backed-up data, which becomes difficult when there are many generations of data.

Therefore, it is desirable to develop a storage apparatus that can increase the usability for the user by making the processes of backing up and recalling data easier and more efficient, irrespective of the number of generations of data.

### SUMMARY OF THE INVENTION

It is an object of the present invention to solve at least the above problems in the conventional technology.

An apparatus for storing data according to one aspect of the present invention includes a first storage unit that stores the data received from other apparatus; a second storage unit that stores the data stored in the first storage unit; a history storage unit that stores information on a storage history of the data that is written from the first storage unit into the second storage unit; and a data recalling unit that reads out the data stored in the second storage unit and stores the data read out to the first storage unit based on the information on the storage history.

An apparatus for storing data according to another aspect of the present invention includes a first storage unit; a second storage unit; a history storage unit that stores information on a storage history of data stored in the second storage unit; and a controller that reads out the data that matches a specific condition from among the data stored in the second storage unit, and transfers the data read out to the first storage unit, based on the information on the storage history.

A method of storing data according to still another aspect of the present invention includes storing the data received from other apparatus in a first storage unit; writing the data stored in the first storage unit into a second storage unit; storing information on a storage history of the data that is written from the first storage unit into the second storage unit; and reading out the data stored in the second storage unit and storing the data read out to the first storage unit based on the information on the storage history.

A method of storing data according to still another aspect of the present invention includes storing the data in a first storage unit; writing the data stored in the first storage unit into a second storage unit; storing information on a storage history of the data stored in the second storage unit; reading out the data that matches a specific condition from among the data stored in the second storage unit; and transferring the data read out to the first storage unit, based on the information on the storage history.

A computer-readable recording medium according to still another aspect of the present invention stores therein a computer program that causes a computer to execute the above methods according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an explanatory diagram of a data backup process of a data storage apparatus according to the present invention;

FIG. 2 is an explanatory diagram of a concept of a data storage process according to the present invention;

FIG. 3 is a functional configuration diagram of a data storage apparatus according to a first embodiment of the present invention;

FIG. 4 is an example of checkpoint data shown in FIG. 3;

FIG. 5 is an example of storage history data shown in FIG. 3;

FIG. 6 is a flowchart of a processing procedure of a data backup process according to the first embodiment;

FIG. 7 is a flowchart of a processing procedure of a data recall process according to the first embodiment;

FIG. 8 is an example of storage history data according to a second embodiment of the present invention; and

FIG. 9 is a block diagram of the hardware configuration of a computer that executes data storage processing.

### DETAILED DESCRIPTION

Exemplary embodiments of a method and an apparatus for storing data, and a computer program according to the present invention will be explained in detail with reference to the accompanying drawings.

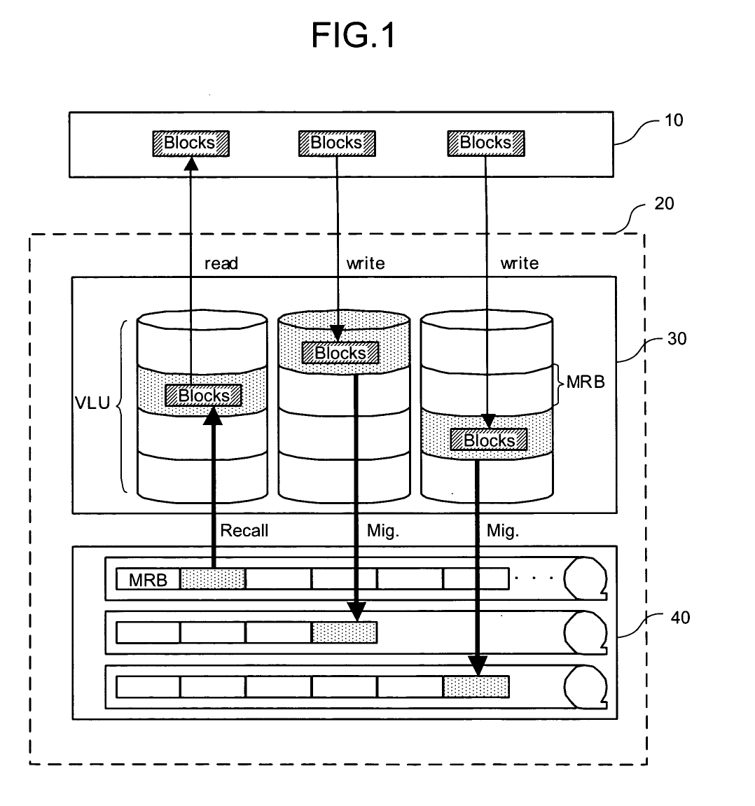

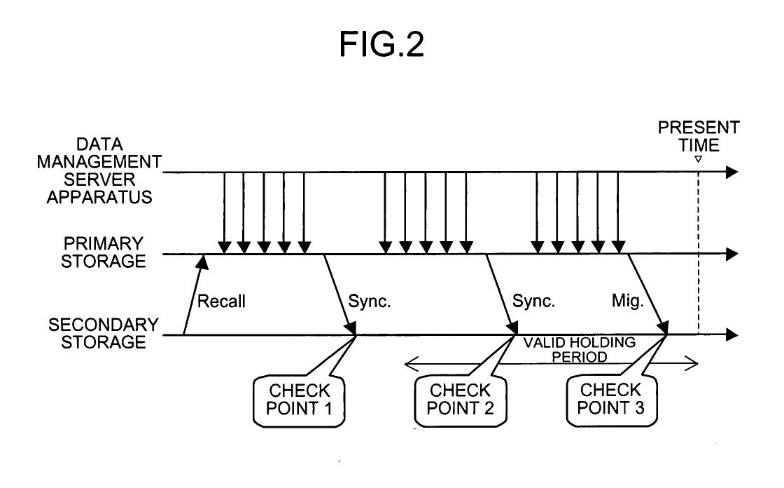

FIG. 1 is an explanatory diagram of a data backup process of a data storage apparatus 20 according to the present invention, and FIG. 2 is an explanatory diagram of a concept of a data storage process according to the present invention.

As shown in FIG. 1, a data management server apparatus 10 accesses a data storage apparatus 20, and reads/writes data in block units. The data management server apparatus 10 manages text, images, or research test results, and the like. The data storage apparatus 20 receives a data read/write request from the data management server apparatus 10 and executes data read/write processing accordingly.

The data storage apparatus 20 uses a hard disk apparatus as its primary storage 30, and a magnetic tape storage apparatus as its secondary storage 40. The primary storage 30 utilizes redundant arrays of independent disks (RAID) technology to manage a plurality of hard disk apparatuses together as a single hard disk apparatus.

The volume of each hard disk apparatus is managed as a virtual logical unit (VLU). In addition, each VLU is divided into migration/recall blocks (MRB) that are the units in which data is read and written in the secondary storage 40. The size of one MRB is normally between several tens of megabytes and several hundred megabytes.

The primary storage 30 stores (writes) data for which a write request is received from the data management server apparatus 10. Then, the data stored in the primary storage 30 is backed up (migrated) by sequential access to the magnetic tape of the secondary storage 40 based on a predetermined stipulation. The magnetic tape of the secondary storage 40 is a write-once recording medium that writes new data behind data that is written previously.

Among the data that is migrated to the magnetic tape of the secondary storage 40, data consulted by the data management server apparatus 10 is recalled as necessary to the primary storage 30, and is read by the data management server apparatus 10.

The primary storage 30 accesses data faster than the secondary storage 40, while the secondary storage 40 has a larger storage capacity than the primary storage 30. Therefore, a storage apparatus that benefits the respective advantages of the primary storage 30 and the secondary storage 40 can be configured by combining them in the manner described above.

Reading and writing of data between the primary storage 30 and the secondary storage 40 is controlled by a data storage management server described later, and the data management server apparatus 10 reads and writes data only to/from the primary storage 30. Therefore, the data management server apparatus 10 can, in effect, use the primary storage 30 as a large-capacity storage apparatus.

As shown in FIG. 2, in a data storage process, data received from the data management server apparatus 10 is stored in the primary storage 30, the stored data is backed up on the magnetic tape of the secondary storage 40, and the data in the primary storage 30 and the data on the magnetic tape of the secondary storage 40 are synchronized.

In this data storage process, the data stored in the primary storage 30 is backed up on the magnetic tape of the secondary storage 40, the data in the primary storage 30 is deleted, and the data is stored (migrated) only on the magnetic tape of the secondary storage 40.

When backing up the data stored in the primary storage 30 on the magnetic tape of the secondary storage 40, the data is written together with its backup date/time as a checkpoint. Then, when a request to recall the backed-up data to the primary storage 30 is received, the user specifies the checkpoint of the data to be recalled, and the data that corresponds to the specified checkpoint is recalled from the magnetic tape of the secondary storage 40 to the primary storage 30.

In this data storage process, a valid holding period of data stored on the magnetic tape of the secondary storage 40 is determined, and data having a checkpoint date/time that is outside the valid holding period is excluded from the data that is migrated to the magnetic tape of the secondary storage 40, and is not recalled to the primary storage 30.

In this way, a storage history of the data is automatically stored when backing up the data, and the data is recalled based on its storage history, thereby enabling the processes of backing up and recalling the data to be performed easily and efficiently, and increasing the usability for the user. Furthermore, a large capacity of data can be stored by combining the primary storage 30 and the secondary storage 40.

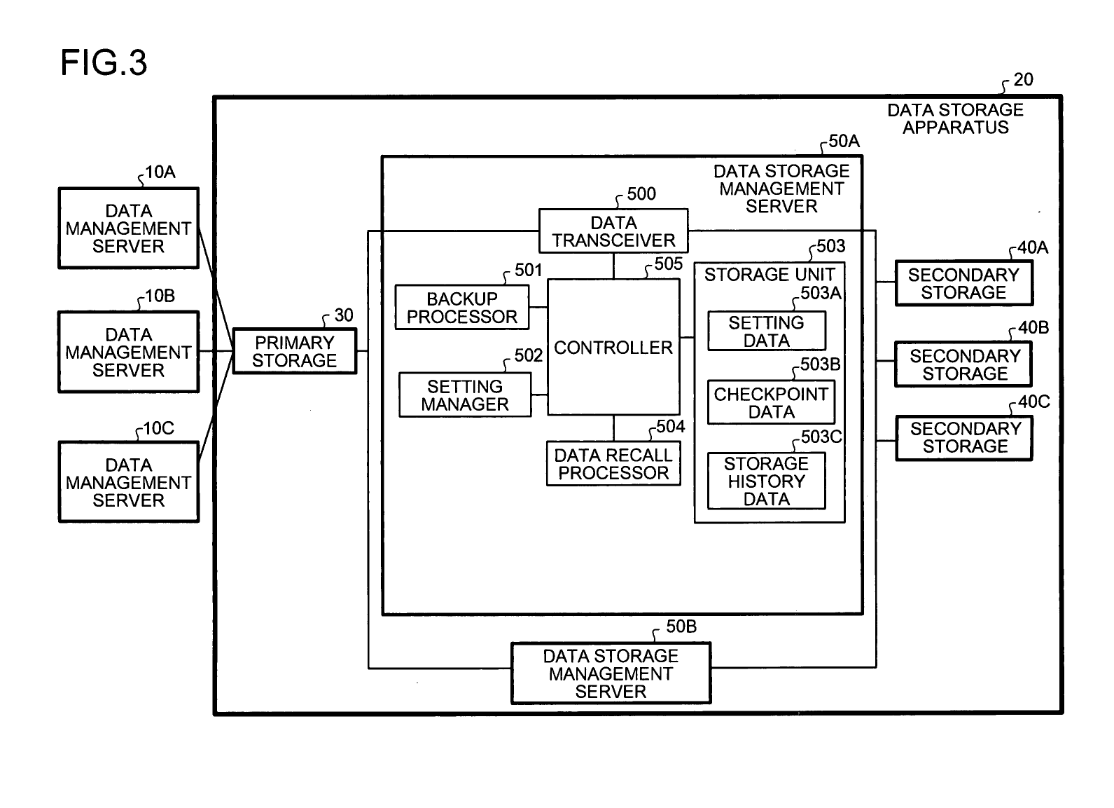

The functional configuration of a data storage apparatus according to a first embodiment will be explained next. FIG. 3 is a functional configuration diagram of the data storage apparatus 20 according to the first embodiment. As shown in FIG. 3, the data storage apparatus 20 is connected via data management server apparatuses 10a to 10c and a network. The data management server apparatuses 10a to 10c correspond to the data management server apparatus 10 described with reference to FIG. 1.

The data storage apparatus 20 is configured by connecting the primary storage 30, data storage management servers 50a and 50b, and secondary storages 40a to 40c. The primary storage 30 corresponds to the hard disk apparatus described with reference to FIG. 1, and the secondary storages 40a to 40c correspond to the magnetic tape storage apparatus that constitutes the secondary storage 40 described with reference to FIG. 1.

The data storage management servers 50a and 50b migrate data stored in the primary storage 30 to the magnetic tapes of the secondary storages 40a to 40c, and, where necessary, recall data that is migrated to the magnetic tapes of the secondary storages 40a to 40c to the primary storage 30. In FIG. 3, two data storage management servers 50a and 50b are provided as a precaution against breakdown or the like.

Each of the data storage management servers 50a and 50b includes a data transceiver 500, a backup processor 501, a setting manager 502, a storage unit 503, a data recall processor 504, and a controller 505. Since the data storage management server 50b has the same configuration as the data storage management server 50a, its inclusive functional parts are not shown in FIG. 3.

The data transceiver 500 exchanges data between the primary storage 30 and the secondary storages 40a to 40c. The backup processor 501 performs backup by writing data stored in the primary storage 30 to the magnetic tapes of the secondary storages 40a to 40c.

Specifically, when the set date/time for executing backup is reached, the backup processor 501 makes a back-up of the data stored in the primary storage 30 in units of MRB by writing it on the magnetic tapes of the secondary storages 40a to 40c in compliance with a preset stipulation.

When backing up data stored in the primary storage 30, the backup processor 501 writes storage history information, which relates to data stored on the magnetic tapes of the secondary storages 40a to 40c, in the storage unit 503 as storage history data 503c.

The setting manager 502 receives information relating to settings, such as the backup date/time, and stores it as setting data 503a in the storage unit 503. The user can perform setting from the data management server apparatuses 10a to 10c, and the primary storage 30 transmits the information relating to the settings, transmitted from the data management server apparatuses 10a to 10c, to the setting manager 502.

The storage unit 503 is a storage device such as a hard disk apparatus. The storage unit 503 stores the setting data 503a, the checkpoint data 503b, and the storage history data 503c. The setting data 503a relates to settings, such as the backup date/time.

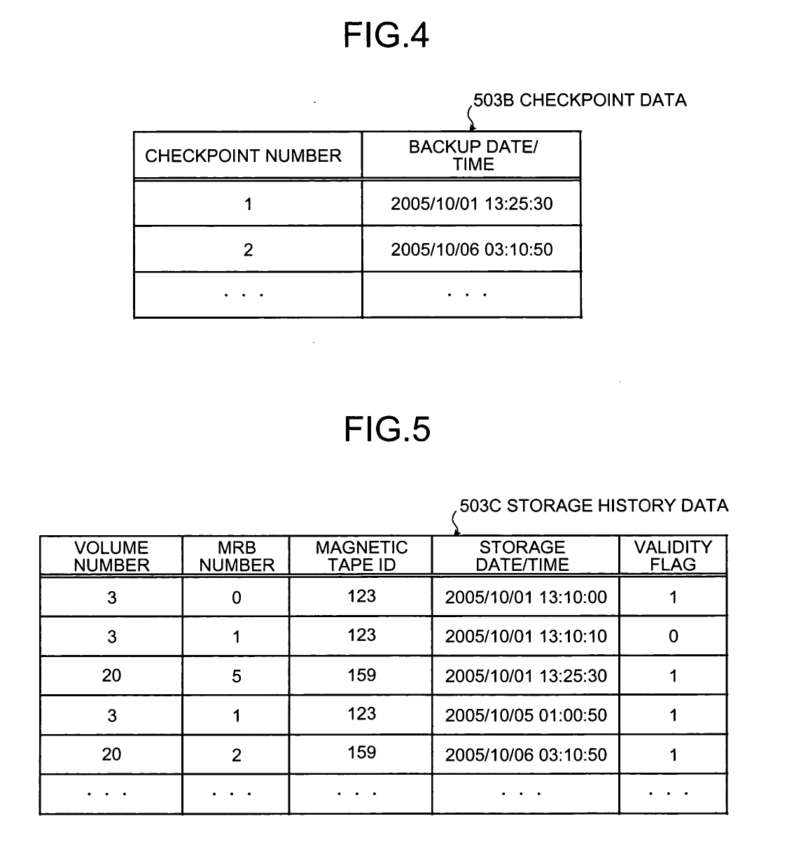

The checkpoint data 503b is information relating to the checkpoint data migrated from the primary storage 30 to the magnetic tapes of the secondary storage 40 at the time of backup. FIG. 4 is an example of the checkpoint data 503b shown in FIG. 3.

As shown in FIG. 4, the checkpoint data 503b includes a checkpoint number and a backup date/time. The checkpoint number identifies the date/time at which data stored in the primary storage 30 is backed up on the magnetic tape of the secondary storage 40. The backup date/time is the date and time when the data stored in the primary storage 30 is backed up on the magnetic tape of the secondary storage 40.

By specifying a checkpoint number, the user can recall data, which is backed up on the magnetic tape of the secondary storage 40 at the date/time corresponding to the checkpoint number, to the primary storage 30.

The storage history data 503c relates to the history of the process of storing data that is stored in the primary storage 30 on the magnetic tapes of the secondary storages 40a to 40c. FIG. 5 is an example of the storage history data 503c shown in FIG. 3.

As shown in FIG. 5, the storage history data 503c includes a volume number, an MRB number, a magnetic tape ID, a storage date/time, and a validity flag. The volume number is allocated to each VLU of the primary storage 30, and is data that represents the VLU where the migrated data is stored.

The MRB number is allocated to each MRB in the VLU, and represents the MRB in which the migrated data is stored. The magnetic tape ID is an identification number allocated to a magnetic tape to which data has been migrated. The storage date/time is the date and time at which the data is stored on the magnetic tape.

A validity flag is information indicating which data is to be recalled from the magnetic tapes of the secondary storages 40a to 40c to the primary storage 30. In the example shown in FIG. 5, a flag of “1” represents that this is valid data to be recalled to the primary storage 30, and a flag of “0” represents that this is not valid data to be recalled to the primary storage 30.

When data is stored on the magnetic tapes of the secondary storages 40a to 40c, the validity flag of this data is set to “1”. Then, based on the volume number and the MRB number, it is determined whether the secondary storages 40a to 40c already store data that is stored in the same storage region of the primary storage 30 as the one where the data is stored, and if it is determined so, the validity flag corresponding to this data is set to “0”.

When a request for processing to recall data from the secondary storages 40a to 40c to the primary storage 30 is received from a user, data that is most recent, with respect to the date/time corresponding to the checkpoint number specified by the user, is extracted from the data that is stored on the magnetic tapes of the secondary storages 40a to 40c prior to the date/time corresponding to the checkpoint number specified by the user, and also stored in the same storage region of the primary storage 30, the validity flag corresponding to the most recent data is set to “1”, and the validity flag corresponding to the old data is set to “0”. Then, the data having the validity flag of “1” is recalled to the primary storage 30.

Although the data storage region of the magnetic tape is divided into blocks (MRB), which are the units for reading and writing data, the storage history data 503b does not include any information relating to the block that represents the position where the data is stored on the magnetic tape. However, since information relating to the data storage history is added to the storage history data 503c each time data is stored sequentially from the head block of the magnetic tape, the block where the data is stored on the magnetic tape identified by the magnetic tape ID can be identified by the number of storage histories of the data for each magnetic tape for which the magnetic tape ID is the same.

Returning to FIG. 3, when the data recall processor 504 receives a specified checkpoint from a user, the data recall processor 504 recalls data corresponding to the checkpoint from among the data backed up on the magnetic tapes of the secondary storages 40a to 40c to the primary storage 30.

More specifically, the data recall processor 504 consults the checkpoint data 503b, and extracts information relating to the backup date/time of the data that corresponds to the checkpoint received from the user.

The data recall processor 504 extracts the most recent data with respect to the date/time corresponding to the checkpoint number, which is specified by the user, from among the data stored on the magnetic tapes of the secondary storages 40a to 40c prior to the backup /time that corresponds to the checkpoint, and also stored in the same storage region of the primary storage 30, sets the validity flag corresponding to the most recent data to “1”, and sets the validity flag corresponding to the old data to “0”. Then, the data recall processor 504 recalls the data having the validity flag of “1” to the primary storage 30.

The controller 505 controls the entire data storage management server 50a, overseeing exchange of data between its functional parts, and the like.

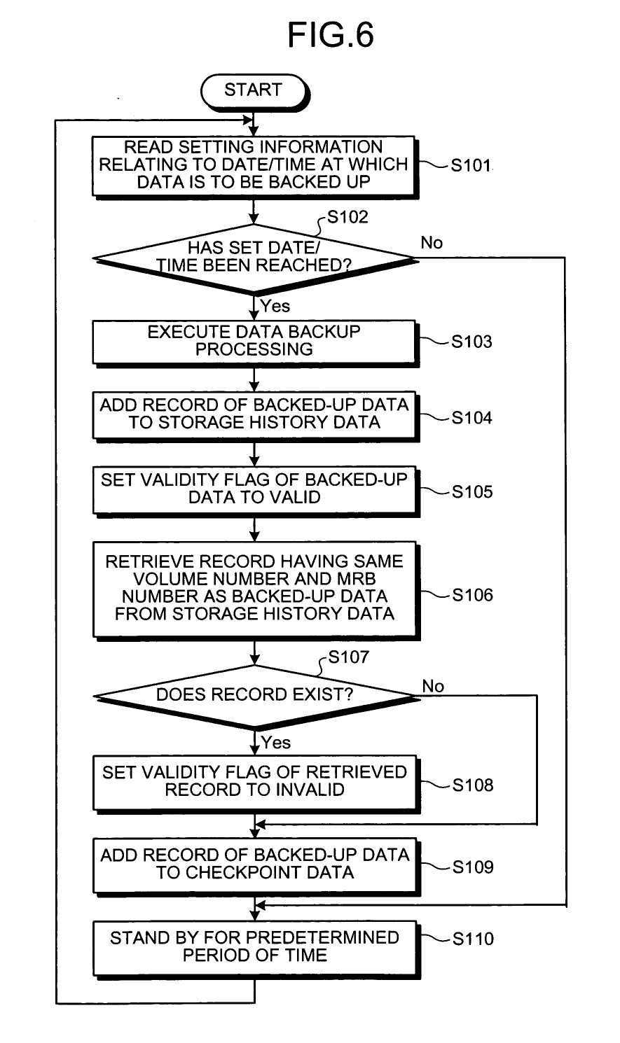

A processing procedure of a data backup process according to the first embodiment will be explained next. FIG. 6 is a flowchart of a processing procedure of a data backup process according to the first embodiment. In this process, data stored in the primary storage 30 is backed up in MRB units of the VLU on the magnetic tapes of the secondary storages 40a to 40c.

As shown in FIG. 6, firstly, the backup processor 501 of the data storage management server 50a reads information relating to the set date/time at which the data is to be backed up from the setting data 503a (step S101).

The backup processor 501 then determines whether the set date/time for backup has been reached (step S102), and if not (step S102, No), stands by for a predetermined period of time (step S110), proceeds directly to step S101, and once again reads information relating to the set date/time at which the data is to be backed up.

When the set date/time has been reached (step S102, Yes), the backup processor 501 writes the data stored in the primary storage 30 into the secondary storages 40a to 40c, as backup for the data being stored (step S103). This backup process may be performed for data stored in a single MRB, or for data stored in a plurality of MRBs.

The backup processor 501 then writes a record of the backed-up data in the storage history data 503c (step S104). The backup processor 501 then sets the validity flag of the backed-up data in the storage history data 503c to “1” (step S105).

The backup processor 501 thereafter retrieves records having the same volume number and MRB number as the backed-up data from the storage history data 503c (step S106), and determines whether the same record exists (step S107).

When there is a record having the same volume number and MRB number as the backed-up data (step S107, Yes), the backup processor 501 sets the validity flag of the retrieved record to “0”, indicating that it is invalid (step S108).

The backup processor 501 writes a record indicating the backup date/time and checkpoint number of the backed-up data in the checkpoint data 503b (step S109), whereby the data backup processing ends.

At step S108, when there is no record having the same volume number and MRB number as the backed-up data (step S107, No), the backup processor 501 proceeds to step S109, and writes a record of the backed-up data in the checkpoint data 503b.

In the process described above, data is backed up when a preset date/time set is reached, but the process may be executed when a request for a backup process is received from a user.

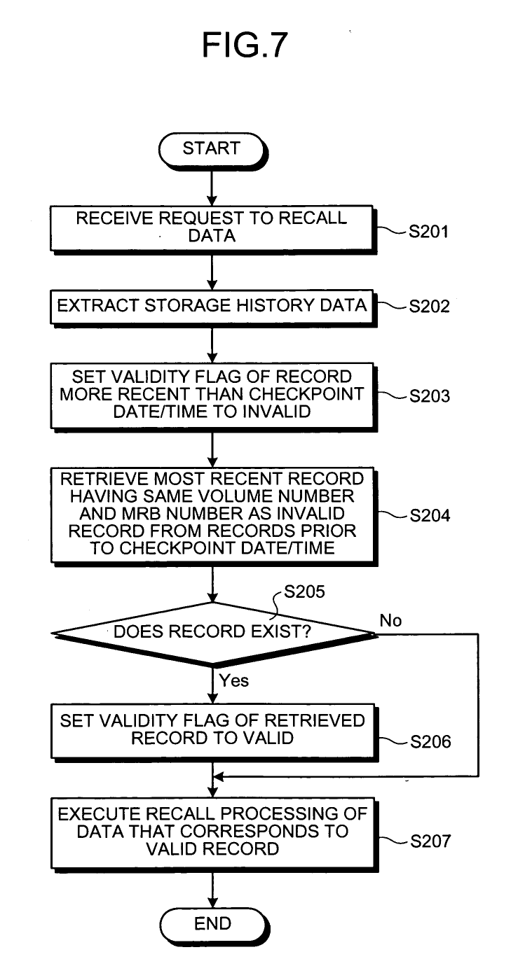

A processing procedure of a data recall process according to the first embodiment will be explained next. FIG. 7 is a flowchart of a processing procedure of the data recall process according to the first embodiment.

As shown in FIG. 7, firstly, the data recall processor 504 of the data storage management server 50a receives a request to recall data from a user (step S201). Thereafter, the data recall processor 504 extracts the storage history data 503c (step S202), and sets the validity flags of the records having a date/time more recent than the backup date/time of the checkpoint specified by the user to “0”, indicating that they are invalid (step S203).

The data recall processor 504 then retrieves the most recent record from the records prior to the checkpoint backup date/time from among the records having the same volume number and MRB number as the records whose flags are set to invalid “0” (step S204), and determines whether there is a record having the same volume number and MRB number as the record whose flag is set to invalid “0” (step S205).

When there is such a record (step S205, Yes), the data recall processor 504 sets the validity flag of the retrieved record to “1”, indicating that it is valid (step S206), and writes the data corresponding to the valid record in the primary storage 30, thereby executing the process of recalling the data (step S207), and the data recall process ends.

When there is no record having the same volume number and MRB number (step S205, No), the data recall processor 504 proceeds directly to step S207, and executes the data recall processing by writing the data corresponding to the valid record in the primary storage 30.

As described above, in the first embodiment, the primary storage 30 stores data received from the data management server apparatuses 10a to 10c, the backup processor 501 writes the data stored in the primary storage 30 on the magnetic tapes of the secondary storages 40a to 40c, and stores information relating to the storage history of the data as storage history data 503c, and based on the storage history data 503c, the data recall processor 504 reads the data stored on the magnetic tapes of the secondary storages 40a to 40c, and stores the read data in the primary storage 30. Therefore, the processes of backing up and recalling data can be easily and efficiently executed, increasing the usability for the user.

In the first embodiment, based on the storage history data 503c, the data recall processor 504 detects the most recent data from among data that is stored in the same storage region of the primary storage 30, and stored on the magnetic tapes of the secondary storages 40a to 40c prior to a predetermined date/time, and stores the detected data in the primary storage 30. Therefore, storage status of the data stored in the primary storage 30 can be easily and efficiently recalled at the specified date/time.

The backup processor 501 writes data stored in the primary storage 30 on the magnetic tapes of the secondary storages 40a to 40c based on a preset schedule in the setting data 503a. Therefore, data stored in the primary storage 30 can be backed up automatically.

When the backup processor 501 has received a request to execute a process of writing data stored in the primary storage 30 on the magnetic tapes of the secondary storages 40a to 40c from a user, the backup processor 501 executes a process of writing the data on the magnetic tapes of the secondary storages 40a to 40c. Therefore, data can be stored on the magnetic tapes of the secondary storages 40a to 40c at a timing specified by the user.

The data recall processor 504 deletes data, which is stored on the magnetic tapes of the secondary storages 40a to 40c prior to a preset time, from the data to be stored in the primary storage 30. Therefore, old data can be deleted automatically.

When a request to execute a process of storing data stored on the magnetic tapes of the secondary storages 40a to 40c in the primary storage 30 is received from a user, the data recall processor 504 executes such processing. Therefore, data can be stored in the primary storage 30 at a timing specified by the user.

In a layered storage apparatus in which a hard disk apparatus and a magnetic tape storage apparatus are combined, the data recall processor 504 recalls data from the magnetic tape to the hard disk. Therefore, in the layered storage apparatus in which the hard disk apparatus and the magnetic tape storage apparatus are combined, data can be efficiently recalled from the magnetic tape having a large storage capacity to the rapidly accessible hard disk.

The primary storage 30 and the secondary storages 40a to 40c are provided, and the backup processor 501 stores information relating to the storage history of data, which is stored on the magnetic tapes of the secondary storages 40a to 40c, as storage history data 503c, and based on the storage history data 503c, the data recall processor 504 reads data that matches specific conditions from among the data stored on the magnetic tapes of the secondary storages 40a to 40c, and transfers the read data to the primary storage 30. Therefore, the data recall process can be executed easily and efficiently, increasing the usability for the user.

Information relating to the storage history of the data is set in each write unit (MRB) of the magnetic tapes of the secondary storages 40a to 40c. Therefore, the data can be recalled easily and efficiently in the write units (MRB) of the magnetic tapes of the secondary storages 40a to 40c, increasing the usability for the user.

Information relating to the storage history of the data includes information indicating whether the data is valid, data that is indicated to be valid by the information in the storage history is read from the magnetic tapes of the secondary storages 40a to 40c, and the read data is transferred to the primary storage 30. Therefore, it is possible to ensure that only valid data is easily and efficiently recalled to the primary storage 30.

In the first embodiment, each time data stored in the primary storage 30 is written on the magnetic tapes of the secondary storages 40a to 40c, history information, such as the storage date/time, is newly added to the storage history data 503c, however, when the data stored in the primary storage 30 has been updated, it is acceptable to delete information that corresponds to the pre-updated invalid data from the storage history data 503c, and write only information that corresponds to updated valid data in the storage history data 503c, making the data recall process more efficient.

According to a second embodiment of the present invention, an example in which, when data stored in the primary storage 30 is updated and migrated to the magnetic tapes of the secondary storages 40a to 40c, history information corresponding to pre-updated data is deleted from the storage history data 503c is explained.

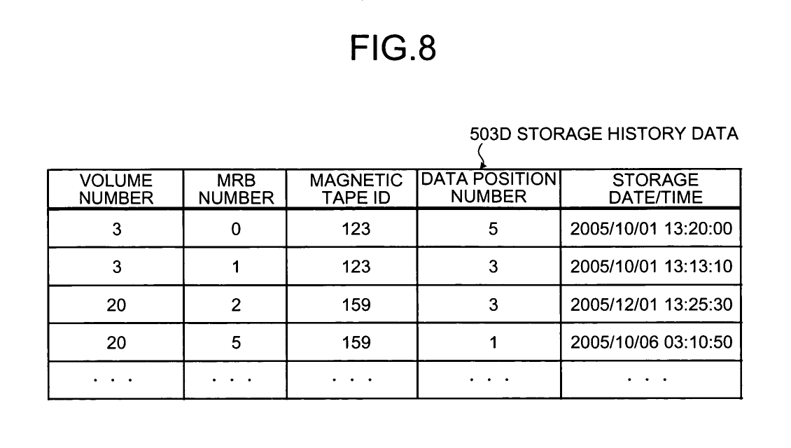

FIG. 8 is an example of storage history data 503d according to the second embodiment. As shown in FIG. 8, the storage history data 503d stores volume numbers, MRB numbers, magnetic tape IDs, data position numbers, and storage date/time.

The volume numbers, the MRB numbers, magnetic tape IDs, and storage date/time, are the same as those shown in FIG. 5.

A data position number represents the position where data is stored on the magnetic tape identified by the magnetic tape ID. The magnetic tape is divided into storage regions including blocks (MRB), being the units for reading and writing data, and a data position number is allocated to each block sequentially from the head block.

In the second embodiment, each time the backup processor 501 of the data storage management servers 50a and 50b shown in FIG. 3 migrates data stored in the primary storage 30 to the magnetic tapes of the secondary storages 40a to 40c, information relating to the storage history of the data is added to the storage history data 503d.

When the data stored in the primary storage 30 is updated and migrated to the magnetic tapes of the secondary storages 40a to 40c, the backup processor 501 deletes information of storage histories of pre-updated data (that is, data that has become invalid) from the storage history data 503d, and adds information of storage histories of the updated data.

When the data stored in the primary storage 30 is backed up, the backup processor 501 separately saves the storage history data 503d at the time when backup is carried out, and updates only one storage history data 503d.

This enables the backup processor 501 to read the storage history data 503d that corresponds to the date/time of the checkpoint, specified by the user, from the saved storage history data 503d, and to return the primary storage 30 to its former status.

As described above, in the second embodiment, when data stored in the primary storage 30 is updated, and the updated data is written on the magnetic tapes of the secondary storages 40a to 40c, where pre-updated data is stored, the backup processor 501 stores information relating to the storage history of the updated data in the storage history data 503d, and deletes information relating to the storage history of the pre-updated data. Therefore, only the required data is registered in the storage history data 503d, enabling the process of recalling data to the primary storage 30 to be executed efficiently.

In the second embodiment, the backup processor 501 saves the storage history data 503d, in which the storage histories of data stored on the magnetic tapes of the secondary storages 40a to 40c are registered, at a plurality of times, and, based on one storage history data 503d that has been selected from among the saved storage history data 503d, the data recall processor 504 writes the data stored on the magnetic tapes of the secondary storages 40a to 40c into the primary storage 30. Therefore, the storage status of the data stored in the primary storage 30 can be efficiently returned to its former status.

The first and the second embodiments describe examples where the data storage processing is executed by a computer, but a program for executing data storage processing may be stored on a computer-readable recording medium to execute the data storage processing, the program stored on the recording medium being read and executed by the computer.

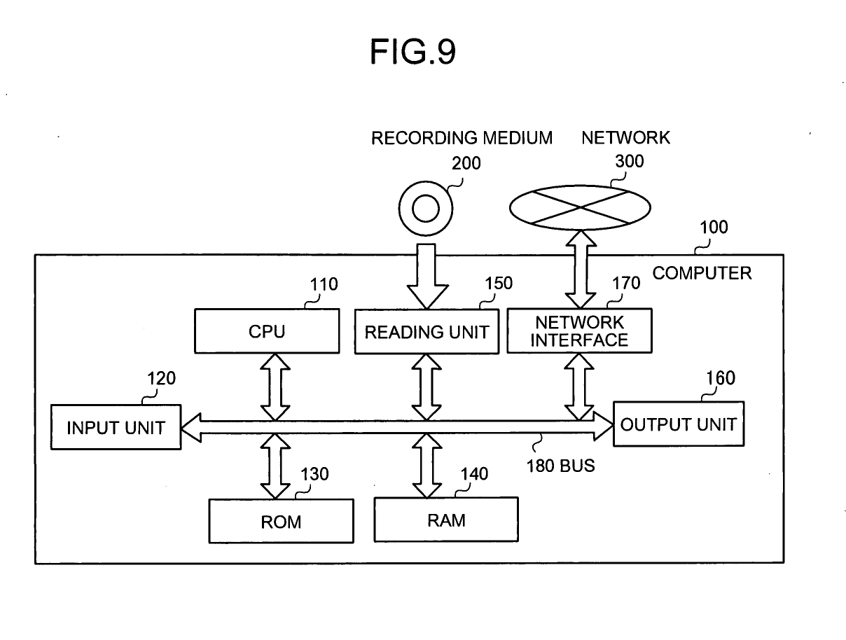

FIG. 9 is a block diagram of the hardware configuration of a computer 100 that executes data storage processing. As shown in FIG. 9, the computer 100 includes a central processing unit (CPU) 110 that executes the program mentioned above, an input apparatus 120 that inputs data, a read only memory (ROM) 130 that stores various types of data, a random access memory (RAM) 140 that stores calculation parameters and the like, a reading apparatus 150 that reads a program for executing data storage processing from a recording medium 200, on which the program is recorded, an output apparatus 160 such as a display, and a network interface 170 that exchanges data with another computer via a network 300, these parts being connected by a bus 180.

The CPU 110 reads the program recorded on the recording medium 200 via the reading apparatus 150, and then carries out data storage processing by executing the program. The recording medium 200 may be an optical disk, a flexible disk, a CD-ROM, a hard disk, or the like. The program may be led into the computer 100 via the network 300.

While exemplary embodiments of the present invention are described above, variously modified embodiments other than the ones described can be made within the technical spirit of the appended claims.

For example, in the first and the second embodiments, the secondary storages 40a to 40c are magnetic tape storage apparatuses that store data on magnetic tapes, but the present invention is not restricted to this, and can be applied in other apparatuses, such as an optical disk library, it being necessary only that the apparatus can store data in a recording medium that stores data by sequential access.

Of the respective processing explained in the embodiments, all or a part of the processing explained as being performed automatically may be performed manually, or all or a part of the processing explained as being performed manually may be performed automatically in a known method.

The information including the processing procedure, the control procedure, specific names, and various kinds of data and parameters shown in the data or in the drawing can be optionally changed, unless otherwise specified.

The respective constituents of the illustrated apparatus are functionally conceptual, and the physically same configuration is not always necessary. In other words, the specific mode of dispersion and integration of the apparatus is not limited to the illustrated one, and all or a part thereof may be functionally or physically dispersed or integrated in an optional unit, according to the various kinds of load and the status of use.

All or an optional part of the various processing functions performed by the apparatus can be realized by the CPU or a program analyzed and executed by the CPU, or can be realized as hardware by the wired logic.

According to the present invention, a first storage unit stores data that is received from another apparatus, a second storage unit writes and stores the data stored in the first storage unit, and stores information relating to the storage history of the data that is written from the first storage unit into the second storage unit, and based on information relating to the storage history that is stored, the data stored in the second storage unit is read out and stored in the first storage unit. Therefore, the invention achieves the effect that processes of backing up and recalling data can be executed easily and efficiently, increasing the usability for the user.

According to the present invention, based on information relating to the storage history, the most recent data is detected from among data that is stored in the same storage region of the first storage unit, and stored in the second storage unit prior to a predetermined date/time, and the detected data is written into the first storage unit. Therefore, the invention achieves the effect that the storage status of data in the first storage unit can be easily and efficiently returned to its status at a specified date/time.

According to the present invention, when data stored in the first storage unit is updated, and the updated data is written in the second storage unit that stores pre-updated data, information relating to the storage history of the updated data is also stored, while information relating to the storage history of the pre-updated data is deleted. Therefore, the invention achieves the effect of ensuring that only information relating to the storage history of required data is registered, making the process of recalling the data more efficient.

According to the present invention, information relating to the storage history of data stored in the second storage unit is saved at a plurality of times, and data stored in the second storage unit is written in the first storage unit based on the information relating to one storage history, which is selected from among the saved information relating to data storage history. Therefore, the storage status of data in the first storage unit can be efficiently returned to its former status.

According to the present invention, data stored in the first storage unit is written in the second storage unit based on a preset schedule. Therefore, the invention achieves the effect that data that is stored in the first storage unit can be backed up automatically.

According to the present invention, when a request to execute a process of writing data stored in the first storage unit into the second storage unit is received from a user, the data is written into the second storage unit. Therefore, the invention achieves the effect that the data can be written in the second storage unit at a timing specified by the user.

According to the present invention, data that is stored in the second storage unit prior to a preset time is deleted from data to be written in the first storage unit. Therefore, the invention achieves the effect that old data can be deleted automatically.

According to the present invention, a process of writing data stored in the second storage unit to the first storage unit is executed when a request to execute the process is received from a user. Therefore, the invention achieves the effect that the data can be recalled to the first storage unit at a timing specified by the user.

According to the present invention, the first storage unit is a hard disk apparatus, and the second storage unit is a magnetic tape storage apparatus. Therefore, the invention achieves the effect that, in a layered storage apparatus in which the hard disk with the magnetic tape are combined, it is possible to efficiently recall data from the magnetic tape having a large storage capacity to the rapidly accessible hard disk.

According to the present invention, the first storage unit and the second storage unit are provided, and information relating to the storage history of data stored in the second storage unit is stored, and based on the information relating to the storage history that is stored, data that matches specific conditions is read from among the data stored in the second storage unit, and the read data is transferred to the first storage unit. Therefore, the invention achieves the effect that the data recall process can be easily and efficiently executed, increasing the usability for the user.

According to the present invention, information relating to the storage history of data is set in each write unit in the second storage unit. Therefore, the invention achieves the effect that the data recall process can be easily and efficiently executed in write units of the second storage unit, increasing the usability for the user.

According to the present invention, information relating to the storage history of the data includes information indicating whether the data is valid, data that is indicated to be valid by the information in the storage history is read from the second storage unit, and the read data is transferred to the first storage unit. Therefore, the invention achieves the effect of ensuring that only valid data is easily and efficiently recalled to the first storage unit.

According to the present invention, information relating to the storage history of data stored in the first storage unit is stored, and, based on the information relating to the storage history that is stored, data that matches specific conditions is read from among the data stored in the first storage unit, and the read data is transferred to the second storage unit. Therefore, the invention achieves the effect that the data recall process can be easily and efficiently executed, increasing the usability for the user.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for storing data received from other apparatus, the apparatus comprising:
a first storage unit that stores the data received from the other apparatus;
a second storage unit that stores the data stored in the first storage unit;
a history storage unit that stores information on a storage history of the data that is written from the first storage unit into the second storage unit; and
a data recalling unit that reads out the data stored in the second storage unit and stores the data read out to the first storage unit based on the information on the storage history.

2. The apparatus according to claim 1, wherein the data recalling unit detects a most recent data from among the data that is stored in same storage area of the first storage unit and stored in the second storage unit prior to a predetermined date and time, and stores the data detected in the first storage unit, based on the information on the storage history.

3. The apparatus according to claim 1, wherein, when the data stored in the first storage unit is updated and updated data is written in the second storage unit where the data before updating is stored, the history storage unit stores the information on the storage history of the updated data, and deletes the information on the storage history of the data.

4. The apparatus according to claim 3, wherein
the history storage unit saves information on the storage history of the data stored in the second storage unit at a plurality of times, and
the data recalling unit writes the data stored in the second storage unit into the first storage unit based on single storage history information selected from among the storage history information that is saved by the history storage unit.

5. The apparatus according to claim 1, wherein the second storage unit stores the data stored in the first storage unit, based on a preset schedule.

6. The apparatus according to claim 1, wherein the second storage unit executes a process of writing the data stored in the first storage unit into the second storage unit when a request to execute the process is received from a user.

7. The apparatus according to claim 1, wherein the data recalling unit excludes the data stored in the second storage unit prior to a preset time from the data to be stored in the first storage unit.

8. The apparatus according to claim 1, wherein the data recalling unit executes a process of writing the data stored in the second storage unit into the first storage unit when a request to execute the process is received from a user.

9. The apparatus according to claim 1, wherein
the first storage unit is a hard disk drive, and
the second storage unit is a magnetic tape drive.

10. An apparatus for storing data, the apparatus comprising:
a first storage unit;
a second storage unit;
a history storage unit that stores information on a storage history of data stored in the second storage unit; and
a controller that reads out the data that matches a specific condition from among the data stored in the second storage unit, and transfers the data read out to the first storage unit, based on the information on the storage history.

11. The apparatus according to claim 10, wherein the information on the storage history is set for each write unit in the second storage unit.

12. The apparatus according to claim 10, wherein
the information on the storage history includes information indicating whether each of the data is valid, and
the controller reads out the data that is indicated to be valid based on the information relating to the storage history from the second storage unit, and transfers the data read out to the first storage unit.

13. A method of storing data received from other apparatus, the method comprising:
storing the data received from the other apparatus in a first storage unit;
writing the data stored in the first storage unit into a second storage unit;
storing information on a storage history of the data that is written from the first storage unit into the second storage unit; and
reading out the data stored in the second storage unit and storing the data read out to the first storage unit based on the information on the storage history.

14. The method according to claim 13, wherein the recalling includes
detecting a most recent data from among the data that is stored in same storage area of the first storage unit and stored in the second storage unit prior to a predetermined date and time; and
storing the data detected in the first storage unit, based on the information on the storage history.

15. The method according to claim 13, wherein, when the data stored in the first storage unit is updated and updated data is written in the second storage unit where the data before updating is stored, the storing information includes
storing the information on the storage history of the updated data; and
deleting the information on the storage history of the data.

16. The method according to claim 13, wherein
the first storage unit is a hard disk drive, and
the second storage unit is a magnetic tape drive.

17. A method of storing data, the method comprising:
storing the data in a first storage unit;
writing the data stored in the first storage unit into a second storage unit;
storing information on a storage history of the data stored in the second storage unit;
reading out the data that matches a specific condition from among the data stored in the second storage unit; and
transferring the data read out to the first storage unit, based on the information on the storage history.

18. A computer-readable recording medium that stores a computer program for storing data received from other apparatus, wherein the computer program makes a computer execute
storing the data received from the other apparatus in a first storage unit;
writing the data stored in the first storage unit into a second storage unit;
storing information on a storage history of the data that is written from the first storage unit into the second storage unit; and
reading out the data stored in the second storage unit and storing the data read out to the first storage unit based on the information on the storage history.

19. The computer-readable recording medium according to claim 18, wherein the recalling includes
detecting a most recent data from among the data that is stored in same storage area of the first storage unit and stored in the second storage unit prior to a predetermined date and time; and
storing the data detected in the first storage unit, based on the information on the storage history.

20. The computer-readable recording medium according to claim 18, wherein, when the data stored in the first storage unit is updated and updated data is written in the second storage unit where the data before updating is stored, the storing information includes
storing the information on the storage history of the updated data; and
deleting the information on the storage history of the data.

21. The computer-readable recording medium according to claim 18, wherein
the first storage unit is a hard disk drive, and
the second storage unit is a magnetic tape drive.

22. A computer-readable recording medium that stores a computer program for storing data, wherein the computer program makes a computer execute
storing the data in a first storage unit;
writing the data stored in the first storage unit into a second storage unit;
storing information on a storage history of the data stored in the second storage unit;
reading out the data that matches a specific condition from among the data stored in the second storage unit; and
transferring the data read out to the first storage unit, based on the information on the storage history.
